(19) United States
(12) Patent Application Publication
(10) Pub. No.: US 2009/0206711 A1
(43) Pub. Date: Aug. 20, 2009

(54) GARMENT ORGANIZER WITH LOWER PIVOTING ACCESS PANEL

(75) Inventor: James L. Glenn, St. Albans, MO (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: Whitney Design, Inc., Bridgeton, MO (US)

(21) Appl. No.: 12/371,845

(22) Filed: Feb. 16, 2009

Related U.S. Application Data
(60) Provisional application No. 61/029,077, filed on Feb. 15, 2008.

(51) Int. Cl. A47B 87/00; A47B 96/00; E05B 1/00

(52) U.S. Cl. 312/108; 312/109; 16/412

(57) ABSTRACT

An organizer having a top panel and a bottom panel with side panels and a rear panel attached between the top panel and the bottom panel. At least one partition panel attaches to the side panels and rear panel so that the side panels, rear panel, top panel, bottom panel, and at least one partition panel define compartments within the organizer. Each compartment corresponds with an opening, wherein the bottom panel serves as a bottom wall for one compartment and wherein the at least one partition panel serves as a bottom wall for another compartment. At least one access panel moveably attaches to a front edge of at least one compartment and bottom wall. The access panel corresponds to a compartment and the opening for that compartment, the opening being located above the bottom wall to which the access panel is attached. The access panel is sized and shaped to pivot in a downward direction to an open position in which the corresponding opening of the corresponding compartment is open. The access panel also can pivot in an upward direction to a closed position in which the access panel substantially covers its corresponding opening.

### CROSS-REFERENCE TO RELATED APPLICATIONS

This application is related to U.S. Provisional Patent Application No. 61/029,077 filed Feb. 15, 2008 from which priority is claimed, and is hereby incorporated by reference.

### STATEMENT REGARDING FEDERALLY SPONSORED RESEARCH

Not Applicable.

### BACKGROUND OF THE INVENTION

The present invention relates to collapsible garment organizers.

In many homes and other dwellings, storage space within closets is limited. Typically, closets are simply rectangular spaces with a transverse rod extending from one side of the closet to the other and, perhaps, a shelf located above the rod. Many people attempt to enhance the use of this space by incorporating various organizers dedicated to various types of garments, such as, shoe racks and shelves.

One type of organizer used is a garment organizer that hangs from the closet rod. Generally, a garment organizer includes a plurality of vertical compartments with an integrated hanger at the top to engage the closet rod. The walls are usually made from fabric to allow the organizer to collapse into a small space for storage or portability. However, none of the current designs include access panels that can open and close for access to the compartments. Rather, all of the compartments are left open, which allows garments or other items to fall out and provides no privacy for items within the compartments.

Therefore, a collapsible garment organizer is needed with access panels to provide access to various compartments.

### DESCRIPTION OF THE DRAWINGS

In the accompanying drawings which form part of the specification:

FIG. 1 is an orthogonal projection of an organizer;

FIG. 2 is sectional view of a partition panel along 2-2 of FIG. 1;

FIG. 3 is an orthogonal projection of the organizer in a collapsed position; and

FIG. 4 is an orthogonal projection of an alternate embodiment of the organizer.

Corresponding reference numerals indicate corresponding parts throughout the several figures of the drawings.

### DETAILED DESCRIPTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

As shown in FIG. 1, an embodiment of the present disclosure, generally referred to as a garment organizer 10, is a generally rectangular receptacle, including a top panel 12, a bottom panel 14, two continuous vertical side panels 16 and a continuous vertical rear panel 18 connected between the top panel 12 and bottom panel 14. Four partition panels 28 are positioned in substantially horizontal alignment within the organizer 10 to define compartments 20 for supporting storage items. The side edges of the partition panels 28 are attached to the side panels 16 as by sewing, while the rear edge of the partition panels 28 are secured to the rear panel 18 as by sewing. The partition panels 28, side panels 14, and rear panel 18, together with the top panel 12 and bottom panel 14, form five compartments for supporting storage items.

Four of the partition panels 28 define the bottom walls, or floors, of the top four compartments 20. Another compartment 21 is formed above the bottom panel 14. The top-most four compartments 20 are thus formed between the top panel 12 and the lowest of the partitions 28. The compartment 21 is formed above the bottom panel 14, so that panel 14 serves as the bottom wall, or floor, of that compartment 21. The compartments 20 and 21 thus are structured to have generally rectangular front openings 19 formed by the upper-most panels and lower-most panels along with the side panels 16, rear panel 18, the partition panels 28, and top and bottom panels 12 and 14.

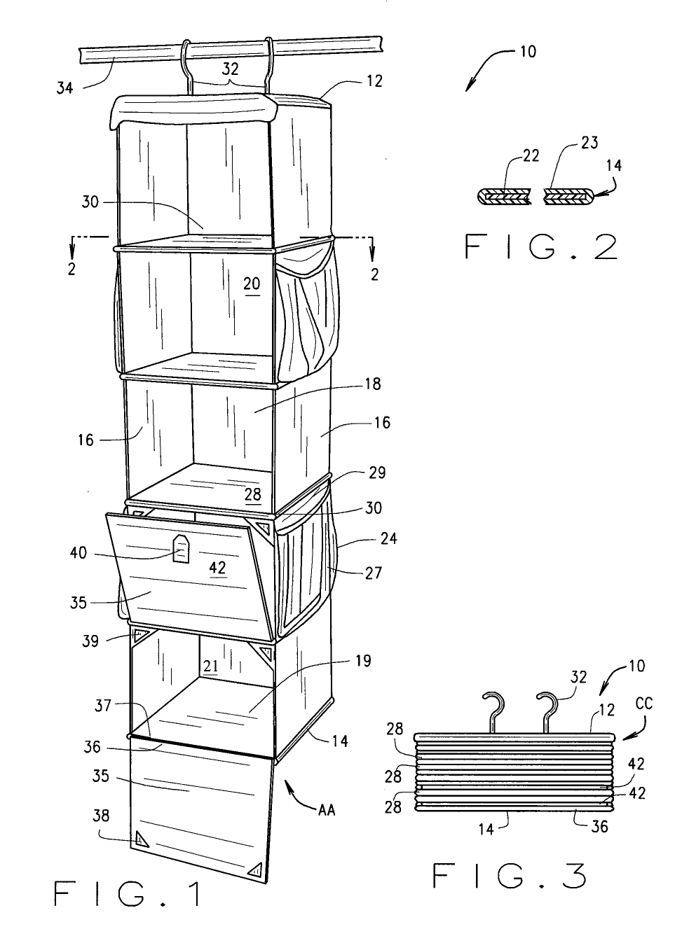

The top panel 12 bottom panel 14, and partition panels 28 all both include a rigid sheet 22 enclosed by a flexible material 23, such as fabric, but other materials can be used, including but not limited to flexible materials made from natural or synthetic materials (FIG. 2). If necessary, support rods (not shown) can be attached along the perimeter of the sheet 22 to provide additional stability and rigidity. The rigid sheet 22 can be made from any appropriate material including, but not limited to cardboard, metal, plastic, and wood. The rigid sheet 22 provides a flat rigid platform to support storage items within each compartment 20.

The side panels 16 and rear panel 18 are continuous panels that extend between the top panel 12 and the bottom panel 14 and attach along the respective three sides of the panels 12 and 14. The side panels 16 and rear panel 18 attach to the top panel 12 and bottom panel 14 preferably by sewing, but can attach by any suitable means, such as adhesives, lamination, or fasteners. The side panels 16 and rear panel 18 of the organizer 10 are preferably made from a flexible material, such as fabric, but other materials can be used, including but not limited to flexible materials made from natural or synthetic materials.

A fabric sheet 24 can be attached to an outer surface 26 of the side panels 16 along the edges and lower edge to provide a pocket 27 for additional storage space. A pocket opening 29 extends along the top edge of sheet 24. The sheets 24 can be made from any appropriate material, such as mesh stretchable fabric or other suitable materials. The sheets 24 can be attached by any suitable means, including, but not limited to sewing or other appropriate means, such as adhesives, lamination, or fasteners.

Although the embodiment of FIG. 1 illustrates the organizer 10 with four partition panels 28, any number of partition panels 28 can be used. The compartments 20 are of generally equal size and are rectangular, but the sizes and shapes of the compartments compartments 20 can vary. In addition, the number of compartments 20 can vary.

The top panel 12 includes a pair of engagement members 32 that have a size and shape to allow them to be suspended from a closet rod 34. In the embodiment of FIG. 1, the engagement members 32 are a pair of hook shaped hangers, but other types of engagement members 32 can be used for engagement with rods or other closet member, such as shelves, doors, hangers, or fasteners. For example, the engagement member 32 can comprise a fabric loop with snaps at the base end, or hook and loop fasteners, such as sold under the Velcro® trademark, or a sleeve.

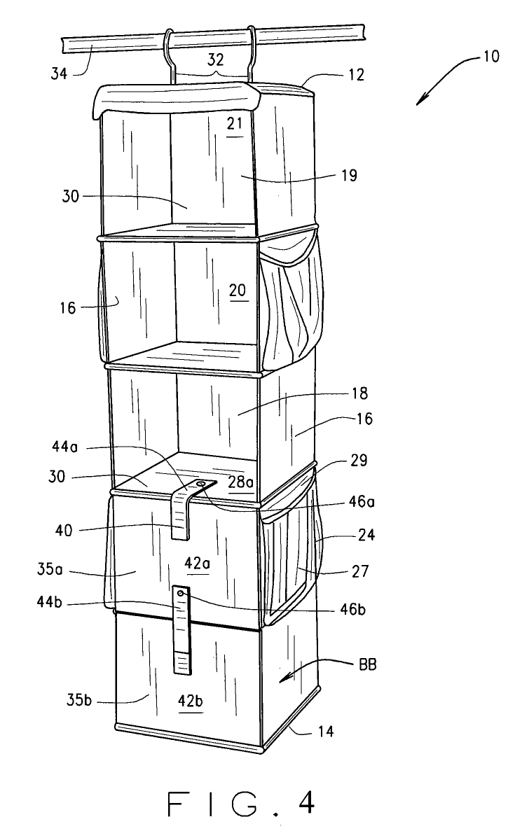

Access panels 35 have proximate edges 36 that are pivotally attached as by stitching to the front edge 37 of selected partition panels 28 so that the access panels 35 can pivot between an open position (AA) (FIG. 1), a closed position (BB)(FIG. 4), and a collapsed position (CC) (FIG. 3). Each panel 35 is preferably shaped and sized to be slightly smaller than the openings 19 of the respective compartments 20. Fasteners 38 are attached at each upper corner of the panel 35 to detachably engage with corresponding tabs 39 attached at the front upper corners of the compartment 20. The fasteners 38 can be positioned at other locations, such as along the front edge of a partition 28 between the corners, or at an intermediate location along the front edge of one or more side panels 16. The corresponding fasteners or tabs 39 on access panels 35 can be positioned to be aligned with fasteners 38. Each panel 35 includes a handle 40 on the front surface 42 sized and shaped to allow an operator to grasp it and move the access panel 35 between the open position (AA)(FIG. 1), the closed position (BB)(FIG. 4), and the collapsed position (CC)(FIG. 3). Prior to collapsing the organizer, the access panel 35 can pivot into the compartment 20 to lay generally flat onto the partition panel 28, referred to as the collapsed position (CC). The tabs 39 should be flexible enough to deflect and allow passage of the access panel 35 through the opening 19 so that the panel 35 can pivot into the compartment 20 to a collapsed position (CC). Once all the access panels 35 are in the collapsed position (CC), the entire organizer 10 can be collapsed with the side panels and rear panel 16 and 18 folding so the top panel 12, partition panels 28, bottom panel 14, and access panel(s) 35 are in proximity with each other to stack on top of one another. This allows the organizer to take up very little space when not in use.

Changes can be made in the above constructions without departing from the scope of the invention. It is intended that all matter contained in the above description or shown in the accompanying drawings shall be interpreted as illustrative and not in a limiting sense. For example, the vertical side panels and rear panels can comprise a plurality of separate panels that are secured to each other as by stitching, or can be secured at their edges to the edges of the partition panels 28.

In an alternate embodiment shown in FIG. 4, a flexible cloth strap 44a has a proximal end secured, as by stitching, to the upper front surface 42a of the panel 35a, with its distal end having a snap, or hook and loop fastener 46a. A corresponding snap or hook and loop fastener is secured to the upper surface of partition panel 28a thereabout so that the fastener 46a at the distal end of strap 44a can fasten thereto to hold the panel 35a to close its corresponding compartment 20. As another alternative, at the bottom of FIG. 4, a strap 44b has its proximal end secured as by stitching to the front surface 42b of panel 35b. A fastener 46b at the distal end of the strap 44b latches with a corresponding fastener secured to the front surface 42a of the panel 35a to hold the the panel to generally cover the opening 19 of its corresponding compartment 20. The strap fastener 46a or 46b can detachably secure to the partition panel 28 or front surface 42, respectively, using any device, including, but not limited to hook and loop fasteners, snaps, and the like.

What is claimed is:

1. A organizer, comprising:
a top panel;
a bottom panel;
a rear panel attached between the top panel and the bottom panel;
at least two side panels, each panel being attached between the top panel and the bottom panel;
at least one partition panel attached to the side panels and rear panel so that the side panels, rear panel, top panel, bottom panel, and at least one partition panel define compartments within the organizer, each compartment having a corresponding opening and wherein the bottom panel serves as a bottom wall for one compartment and wherein the at least one partition panel serves as a bottom wall for another compartment; and
at least one access panel moveably attached to a front edge of at least one compartment and bottom wall, the access panel corresponding to a compartment and the opening for that compartment, the opening being located above the bottom wall to which the access panel is attached, and the access panel being sized and shaped so that the access panel can pivot in a downward direction to an open position in which the corresponding opening of the corresponding compartment is open, and can pivot in an upward direction to a closed position in which the access panel substantially covers its corresponding opening.

2. The organizer of claim 1 wherein the organizer is configured for engaging a closet member, further comprising:
an engagement member attached to the top panel sized so that the engagement member can detachably engage the closet member.

3. The organizer of claim 1, further comprising:
a plurality of partition panels positioned generally horizontally within the organizer and associated with the rear panel, bottom panel, top panel, and side panels to define the compartments for receiving and supporting storage items.

4. The organizer of claim 1, further comprising:
a sheet attached to at least one of the side panels defining a pocket sized and shaped to receive storage items.

5. The organizer of claim 1, wherein the access panel is sized and shaped to be smaller than the corresponding opening of the compartment so that the access panel can pivot from the open position through the corresponding opening and extend to be adjacent a top surface of the corresponding partition.

6. The organizer of claim 1, further comprising:
a fastener attached to the access panel;
a tab attached at a corresponding location of the compartment, wherein the fastener is positioned and aligned so that the access panel can be moved to detachably engage with the tab.

7. The organizer of claim 1, further comprising:
a handle attached to the access panel sized for engagement by an operator for movement of the access panel of the access panel between the open position and the closed position.

8. The organizer of claim 1, wherein the side panels, top panel, bottom panel, rear panel, access panel, and partition panel, are sized and positioned relative to each so that the organizer can collapse with the side panels and rear panel folding so the top panel, access panel, partition panels, and bottom panel are in proximity with each other to stack on top of one another; and
wherein the access panel is sized and shaped to be smaller than the corresponding opening of the compartment so that the access panel can pivot from the open position through the corresponding opening and extend to be adjacent a top surface of the corresponding partition.

9. The organizer of claim 8, further comprising:
a strap having a proximal end secured to the access panel, and having a distal end with a first fastener;
a corresponding second fastener secured to the partition panel to detachably engage with the first fastener to secure the access panel in the closed position; and
wherein the access panel is sized and shaped to be smaller than the corresponding opening of the compartment so that the access panel can pivot from the open position through the corresponding opening and extend to be adjacent a top surface of the corresponding partition.

10. The organizer of claim 1, further comprising:
a first access panel and a second access panel;
a strap having a proximal end secured to the first access panel, and having a distal end with a first fastener;
a corresponding second fastener that can be secured to the second access panel when the second access panel is in a closed position to detachably engage with the first fastener to secure the second access panel in the closed position.

11. A system for storing items in compartments, comprising:
a top panel;
a bottom panel;
a rear panel attached between the top panel and the bottom panel;
at least two side panels, each panel being attached between the top panel and the bottom panel;
at least one partition panel attached to the side panels and rear panel so that the side panels, rear panel, top panel, bottom panel, and at least one partition panel define compartments within the organizer, each compartment having a corresponding opening and wherein the bottom panel serves as a bottom wall for one compartment and wherein the at least one partition panel serves as a bottom wall for another compartment; and
at least one access panel moveably attached to a front edge of at least one compartment and bottom wall, the access panel corresponding to a compartment and the opening for that compartment, the opening being located above the bottom wall to which the access panel is attached, and the access panel being sized and shaped so that the access panel can pivot in a downward direction to an open position in which the corresponding opening of the corresponding compartment is open, and can pivot in an upward direction to a closed position in which the access panel substantially covers its corresponding opening;
wherein the side panels, top panel, bottom panel, rear panel, and partition panels, are sized, shaped, and positioned relative to each so that the organizer can collapse with the side panels and rear panel folding so the top panel, bottom panel, and partition panels, are in proximity with each other to generally stack on top of one another; and
wherein the access panel is sized and shaped to be smaller than the corresponding opening of the compartment so that the access panel can pivot from the open position through the corresponding opening and extend to be adjacent a top surface of the corresponding partition.

12. The system of claim 11 wherein the system is configured for engaging a closet member, further comprising:
an engagement member attached to the top panel sized so that the engagement member can detachably engage the closet member.

13. The system of claim 11, further comprising:
a plurality of partition panels positioned generally horizontally within the organizer and associated with the rear panel, bottom panel, and side panels to define compartments for receiving and supporting storage items.

14. The system of claim 11, further comprising:
a sheet attached to at least one of the side panels defining a pocket sized and shaped to receive storage items.

15. The system of claim 11, wherein the access panel is sized and shaped to be smaller than the opening of the corresponding compartment so that the access panel can pivot from the open position to pass through the opening and extend to be adjacent a top surface of the partition.

16. The system of claim 11, further comprising:
a fastener attached to the access panel;
a tab attached at a corresponding location of the compartment, wherein the fastener is positioned and aligned so that the access panel can be moved to detachably engage with the tab.

17. The system of claim 11, further comprising:
a handle attached to the access panel sized for engagement by an operator for movement between an open and closed position.

18. The system of claim 11, further comprising:
a strap having a proximal end secured to the access panel, and having a distal end with a first fastener; and
a corresponding second fastener that can be secured to the second access panel when the second access panel is in a closed position to detachably engage with the first fastener to secure the second access panel in the closed position.

19. A collapsible organizer, comprising:
a top panel;
a bottom panel;
a rear panel attached between the top panel and the bottom panel;
at least two side panels, each panel being attached between the top panel and the bottom panel;
at least one partition panel attached to the side panels and rear panel so that the side panels, rear panel, top panel, bottom panel, and at least one partition panel define compartments within the organizer, each compartment having a corresponding opening and wherein the bottom panel serves as a bottom wall for one compartment and wherein the at least one partition panel serves as a bottom wall for another compartment;
at least one means for covering the opening of the a corresponding compartment, the means for covering being moveably attached to a front edge of at least compartment and bottom wall, the means for covering corresponding to a compartment and the opening for that compartment, the opening being located above the bottom wall to which the means for covering is attached, and the means for covering being sized and shaped so that the access panel can pivot in a downward direction to an open position in which the corresponding opening of the corresponding compartment is open, and can pivot in an upward direction to a closed position in which the means for covering substantially covers its corresponding opening.

20. The collapsible organizer of claim 19, wherein the side panels, top panel, bottom panel, rear panel, means for covering, and partition panel, are sized and positioned relative to each so that the organizer can collapse with the side panels and rear panel folding so the top panel, means for covering, partition panels, and bottom panel are in proximity with each other to stack on top of one another;
wherein the access panel is sized and shaped to be smaller than the corresponding opening of the compartment so that the access panel can pivot from the open position through the corresponding opening and extend to be adjacent a top surface of the corresponding partition.
